(19) United States
(12) Patent Application Publication
(10) Pub. No.: US 2024/0172118 A1
(43) Pub. Date: May 23, 2024

(54) METHODS AND APPARATUSES FOR POWER SAVING FOR A SIDELINK UE

(71) Applicant: Lenovo (Beijing) Limited, Beijing (CN)

(72) Inventors: Jie Hu, Beijing (CN); Jing Han, Beijing (CN); Haiming Wang, Beijing (CN); Min Xu, Beijing (CN)

(73) Assignee: Lenovo (Beijing) Limited, Beijing (CN)

(21) Appl. No.: 18/552,749

(22) PCT Filed: Apr. 1, 2021
(86) PCT No.: PCT/CN2021/084886

§ 371 Date: Sep. 27, 2023

(51) Int. Cl. H04W 52/02; H04W 76/28

(52) U.S. Cl. CPC H04W 52/0229; H04W 76/28

(57) ABSTRACT

Embodiments of the present application are directed to methods and apparatuses for power saving for a sidelink user equipment (UE). In an embodiment, a method may include: performing candidate sidelink synchronization signal (SLSS) detection to select or reselect a synchronization reference source for a sidelink communication with another UE based on at least one of a time period-based condition and a trigger condition.

### TECHNICAL FIELD

Embodiments of the present application generally relate to wireless communication technologies, and especially to methods and apparatuses for power saving for a sidelink user equipment (UE).

### BACKGROUND

Sidelink enables a direct communication between UEs in proximity, and data does not need to go through a base station (BS) or a core network. For example, in the case that a UE and another UE are relatively close to each other, a radio link or a sidelink can be established to provide device-to-device (D2D) communication. The term “sidelink” refers to a direct radio link for communication among devices, as opposed to communication via the cellular infrastructure (uplink and downlink). The “sidelink” is also referred to as a D2D link. D2D communication may be used in any suitable telecommunication network in accordance with various standards. The network may configure a resource pool for performing the D2D operation to a UE.

D2D operation may provide various advantages, for example, a relatively high transfer rate, a relatively low delay, etc. Moreover, in D2D operation, traffic concentrated on a base station can be distributed. Furthermore, a D2D UE may function as a relay to extend coverage of a base station.

Currently, D2D communication has evolved into vehicle-to-anything (V2X) communication in the long term evolution (LTE) sidelink, and has been introduced into 5G wireless communication technology. V2X communication encompasses communications involving vehicles as message sources or destinations.

In V2X, to achieve synchronization between UEs in a sidelink communication, each UE needs to select a synchronization reference source and uses it when transmitting NR sidelink communication.

According to 3rd Generation partnership project (3GPP) specification TS 38.331, a sidelink UE needs to perform a full-time synchronization search (i.e. covering all sub-frames and all possible SLSS identifiers (SLSSIDs)) for synchronization signal block (SSB) transmitted every 160 ms to detect other candidate SLSS due to potential un-synced synchronization reference for synchronization reference source selection or reselection, which may make the sidelink UE have no chance to fall into a deep sleep and reduce the power saving gain. Therefore, how to realize power saving for a sidelink UE needs to be considered.

### SUMMARY OF THE APPLICATION

Embodiments of the present application provide methods and apparatuses for power saving for a sidelink UE.

Some embodiments of the present application provide a method performed by a first user equipment (UE). The method may include: performing candidate sidelink synchronization signal (SLSS) detection to select or reselect a synchronization reference source for a sidelink communication with a second UE, based on at least one of a time period-based condition and a trigger condition.

In an embodiment of the present application, the first UE may perform the candidate SLSS detection during a sidelink discontinuous reception (DRX) on-duration period and stops the candidate SLSS detection during a sidelink DRX off-duration period when the first UE is configured with a sidelink DRX configuration.

In an embodiment of the present application, the first UE may perform the candidate SLSS detection during a sidelink DRX active time period and stops the candidate SLSS detection during a sidelink DRX inactive time period when the first UE is configured with a sidelink DRX configuration, wherein the sidelink DRX active time period includes a time duration of a sidelink DRX on-duration period and a time duration while a sidelink DRX related timer is running.

In an embodiment of the present application, the first UE may perform the candidate SLSS detection within a specified time duration periodically.

In an embodiment of the present application, a period for performing the candidate SLSS detection and the specified time duration for performing the candidate SLSS detection are configured by a base station (BS) or pre-configured.

In an embodiment of the present application, the period and the specified time duration are configured or pre-configured based on a sidelink DRX configuration when the first UE is configured with the sidelink DRX configuration or based on the BS's implementation or the first UE's implementation.

In an embodiment of the present application, the method may include: stopping the candidate SLSS detection during a specified time window when a new synchronization reference source is selected or reselected.

In an embodiment of the present application, the specified time window is started after the new synchronization reference source is selected or reselected, and a duration of the specified time window is configured by a BS or pre-configured.

In an embodiment of the present application, the first UE may perform the candidate SLSS detection to select or reselect a synchronization reference source for a sidelink communication with the second UE when at least one of the following trigger conditions is met: a quality of service (QOS) requirement of an upcoming service for a sidelink communication with the second UE is within a first threshold range; a measured received power value of a current synchronization reference source of the first UE is lower than a second threshold during a time period; or a range-based signal from a current synchronization reference source of the first UE is within a third threshold range during a time period.

In an embodiment of the present application, in the case that the first UE is directly or indirectly synchronized to a BS, the first UE may perform the candidate SLSS detection to select or reselect a synchronization reference source for a sidelink communication with the second UE when a measurement result indicates that the first UE moves into an edge of a cell of the BS or out of a cell coverage of the BS.

In an embodiment of the present application, in the case that the first UE is directly or indirectly synchronized to a global navigation satellite system (GNSS), the first UE may perform the candidate SLSS detection to select or reselect a synchronization reference source for a sidelink communication with the second UE when the GNSS becomes not reliable.

In an embodiment of the present application, in the case that a current synchronization reference source of the first UE is another UE which is not synchronized to a GNSS or a BS directly or indirectly, the first UE may perform the candidate SLSS detection to select or reselect a synchronization reference source for a sidelink communication with the second UE when at least one of the following trigger conditions is met: the GNSS becomes reliable; or information of at least one cell of a BS is detected.

In an embodiment of the present application, the time period-based condition is configured by a BS with radio resource control (RRC) signaling or system information block (SIB) signaling, or pre-configured.

In an embodiment of the present application, the trigger condition is configured by a BS with RRC signaling or SIB signaling, or pre-configured.

Some embodiments of the present application provide an apparatus. The apparatus may include a processor; a wireless transmitter coupled to the processor; and a wireless receiver coupled to the processor. The processor is configured to perform any of the above methods with the wireless transmitter and the wireless receiver.

The embodiments of the present application can realize power saving for a sidelink UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of an exemplary wireless communication system according to some embodiments of the present application;

FIG. 2 illustrates a flow diagram of an exemplary method for power saving for a sidelink UE according to some embodiments of the present application;

FIG. 3 illustrates a simplified block diagram of an exemplary apparatus according to some embodiments of the present application; and

FIG. 4 illustrates a simplified block diagram of another exemplary apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G. It is contemplated that along with developments of network architectures and new service scenarios, all embodiments in the present application are also applicable to similar technical problems; and moreover, the terminologies recited in the present application may change, which should not affect the principle of the present application.

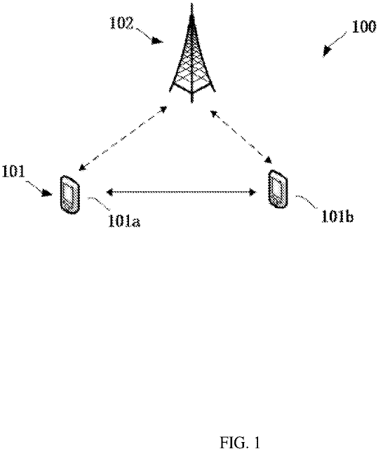

FIG. 1 illustrates a schematic diagram of an exemplary wireless communication system 100 in accordance with some embodiments of the present application.

As shown in FIG. 1, the wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

In the wireless communication system 100 in FIG. 1, it shows a scenario that both the UE 101a and the UE 101b are in coverage of the BS 102. It should be understood that the other two scenarios may also appear in the wireless communication system 100: in a scenario, both the UE 101a and the UE 101b are out of coverage of the BS 102; in another scenario, one UE (e.g., the UE 101a) is in coverage of the BS 102 while another UE (e.g., the UE 101b) is out of coverage.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, the UE(s) 101 may be a pedestrian UE (P-UE or PUE) or cyclist UE. In some embodiments of the present application, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate directly with the BS(s) 102 via LTE or new radio (NR) Uu interface.

In some embodiments of the present application, each of the UE(s) 101 may be deployed an internet of things (IOT) application, an enhanced mobile broadband (eMBB) application and/or an ultra-reliable and low latency communications (URLLC) application. For instance, the UE 101a may implement an IoT application and may be named as an IoT UE, while the UE 101b may implement an eMBB application and/or a URLLC application and may be named as an eMBB UE, a URLLC UE, or an eMBB/URLLC UE. It is contemplated that the specific type of application(s) deployed in the UE(s) 101 may be varied and not limited.

According to some embodiments of FIG. 1, the UE 101a functions as a transmitting (Tx) UE, and the UE 101b functions as a receiving (Rx) UE. The UE 101a may exchange V2X messages with the UE 101b through a sidelink, for example, PC5 interface as defined in 3GPP TS 23.303. The UE 101a may transmit information or data to other UE(s) within the V2X communication system, through sidelink unicast, sidelink groupcast, or sidelink broadcast. For instance, the UE 101a may transmit data to the UE 101b in a sidelink unicast session. The UE 101a may transmit data to the UE 101b and other UE(s) in a groupcast group (not shown in FIG. 1) by a sidelink groupcast transmission session. Also, the UE 101a may transmit data to the UE 101b and other UE(s) (not shown in FIG. 1) by a sidelink broadcast transmission session.

Alternatively, according to some other embodiments of FIG. 1, the UE 101b functions as a Tx UE and transmits V2X messages, and the UE 101a functions as an Rx UE and receives the V2X messages from the UE 101b.

Both the UE 101a and the UE 101b in the embodiments of FIG. 1 may transmit information to the BS 102 and receive control information from the BS 102, for example, via LTE or NR Uu interface. The BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. The BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, where the BS(s) 102 transmit data using an OFDM modulation scheme on the downlink (DL) and the UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, the BS(s) 102 may communicate using other communication protocols, such as the IEEE 802.11 family of wireless communication protocols. Further, in some embodiments of the present application, the BS(s) 102 may communicate over licensed spectrums, whereas in other embodiments, the BS(s) 102 may communicate over unlicensed spectrums. The present application is not intended to be limited to the implementation of any particular wireless communication system architecture or protocol. In yet some embodiments of present application, the BS(s) 102 may communicate with the UE(s) 101 using the 3GPP 5G protocols.

Discontinuous reception (DRX) refers to a working mode for saving power consumption of a UE. When DRX is configured for a UE, the UE does not have to continuously monitor physical downlink control channel (PDCCH). For example, generally, in the DRX mode, the UE alternates between an active state and an inactive state (or a sleep state). The UE only turns on the receiver to monitor and receive control information or data when it is in the active state, and turns off the receiver to stop receiving and decoding the control information or data when it is in the inactive state. Release (Rel)-16 NR sidelink is enabled based on the assumption of “always-on” when the UE operates in sidelink. Solutions for power saving in Rel-17 are required for vulnerable road users (VRUs) in V2X use cases and for UEs in public safety and commercial use cases where power consumption in the UEs needs to be minimized. Therefore, DRX operation is introduced in Rel-17 sidelink to make a UE fall into a deep sleep by switching off RF for power saving purpose when there is no traffic for a while.

As discussed as above, in V2X, to achieve synchronization between UEs in a sidelink communication, each UE needs to select a synchronization reference source as a synchronization reference and uses it when transmitting NR sidelink communication. The synchronization reference sources of NR V2X may include global navigation satellite system (GNSS), gNB, eNB and LTE/NR UE. According to requirements defined in 3rd Generation Partnership Project (3GPP) TS 38.133, when a serving cell, GNSS or a synchronization reference UE has been determined as a synchronization reference source for a UE, the UE shall not drop any V2X sidelink synchronization signal (SLSS) and data transmission for the purpose of selection or reselection to other potential synchronization reference source. The selection or reselection of the potential synchronization reference source may be based on the specified synchronization reference source priority as shown in Table 1 below. As shown in Table 1, the priority rule may include GNSS-based synchronization priority rules and gNB/eNB-based synchronization priority rules, and the UE may be configured or pre-configured to adopt the GNSS-based synchronization priority rules or the gNB/eNB-based synchronization priority rules.

In the two types of synchronization priority rules, each synchronization source has a different priority. Table 1 shows a priority group of synchronization reference sources in R16 NR V2X. In Table 1, the priority of each synchronization reference source is sorted from high to low. That is, P0 indicates the highest priority.

TABLE 1

| Priority | GNSS-based | gNB/eNB based |
|---|---|---|
| level | synchronization | synchronization |
| P0 | GNSS | gNB/eNB |
| P1 | All UEs directly | All UEs directly |
| | synchronized to GNSS | synchronized to gNB/eNB |
| P2 | All UEs indirectly | All UEs indirectly |
| | synchronized to GNSS | synchronized to gNB/eNB |
| P3 | Any other UEs | GNSS |
| P4 | N/A | All UEs directly |
| | | synchronized to GNSS |
| P5 | N/A | All UEs indirectly |
| | | synchronized to GNSS |
| P6 | N/A | Any other UEs |

Also as defined in 3GPP TS 38.331, a sidelink UE needs to perform a full-time synchronization search (i.e. covering all sub-frames and all possible SLSSIDs) for SSB transmitted every 160 ms to detect other candidate SLSS(s) due to potential un-synced synchronization reference, e.g. synchronization reference UEs are unlikely synced with their synchronization reference sources especially in the tunnel or underground scenarios. Considering this, a sidelink UE is likely to perform a full-time synchronization search with no chance to switch off RF completely, i.e. no chance to fall into deep sleep.

In the embodiments of the present application, a periodic, aperiodic, or event-based candidate SLSS detection is proposed for power saving of a sidelink UE instead of performing a full-time synchronization search.

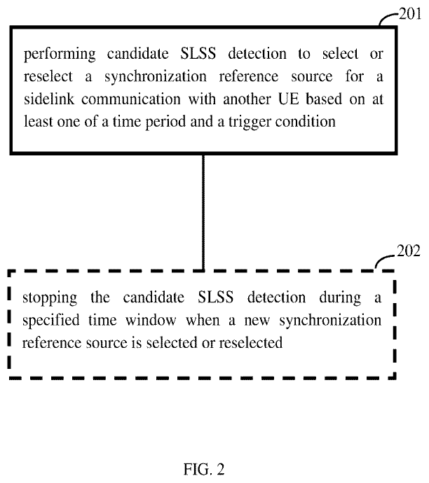

FIG. 2 illustrates a flow diagram of an exemplary method for power saving for a sidelink UE according to some embodiments of the present application. The method illustrated in FIG. 2 may be implemented by a UE (e.g., the UE 101a or 101b in FIG. 1). It should be understood that the method for power saving for a sidelink UE in this embodiment may be used for broadcast, groupcast, and/or unicast.

As shown in FIG. 2, in step 201, a UE may perform candidate sidelink synchronization signal (SLSS) detection to select or reselect a synchronization reference source for a sidelink communication with another UE based on at least one of a time period-based condition and a trigger condition.

In some embodiments, the UE may perform candidate SLSS detection based a sidelink DRX configuration when the UE is configured with the sidelink DRX configuration. For example, the UE may perform candidate SLSS detection based on a time period associated with the sidelink DRX configuration.

As an example, before step 201, the UE may receive the sidelink DRX configuration from a BS, and then perform the candidate SLSS detection according to the sidelink DRX configuration. For example, the BS may transmit the sidelink DRX configuration by a higher layer signaling, such as radio resource control (RRC) signaling, especially, ConnectionReconfiguration or RRCConnection Setup or RRCConnectionReestablishment to the UE. As another example, before step 201, the UE may determine the sidelink DRX configuration from pre-configuration in the UE, e.g. pre-configured sidelink parameters. As yet another example, before step 201, the UE may receive the sidelink DRX configuration from a sidelink peer UE. For example, a sidelink transmitting UE may provide the sidelink DRX configuration to a receiving UE by a higher layer signaling, such as a sidelink RRC signaling.

The sidelink DRX configuration may include values of DRX timers, DRX cycle, and DRX offset value, or the like. For example, the DRX timers may include a DRX on-duration timer, a DRX inactivity timer, a DRX retransmission timer, a hybrid automatic repeat request (HARQ) round-trip time (RTT) timer, or the like. The values of the DRX timers may be indicated by a number of slots or symbols or sub-milliseconds or milliseconds.

For example, the value of the DRX on-duration timer may indicate a sidelink DRX on-duration period, and is used to indicate the duration at the beginning of a DRX cycle. The value of the DRX inactive timer can be used to indicate how long the UE remains active after receiving scheduling signaling of a physical sidelink control channel (PSCCH). The value of retransmission timer can be used to indicate the maximum duration until a sidelink grant for retransmission is received. The value of the HARQ RTT timer can be used to indicate the minimum amount of duration before a sidelink grant for HARQ retransmission is expected by the UE.

In an embodiment of the present application, the UE only performs the candidate SLSS detection within sidelink DRX on-duration time when the UE is configured with DRX operation. For example, the UE may perform the candidate SLSS detection during a sidelink DRX on-duration period and stop the candidate SLSS detection during a sidelink DRX off-duration period when the UE is configured with a sidelink DRX configuration. In other words, the time period for the UE's performing the candidate SLSS detection starts from the beginning of the on-duration and stops at the end of the on-duration for a specific sidelink DRX cycle. The time period for the UE's stopping the candidate SLSS detection starts from the beginning of the off-duration and stops at the end of the off-duration for a specific sidelink DRX cycle. “UE performs the candidate SLSS detection” means that when a sidelink UE has selected an serving cell, GNSS, or a synchronization reference UE as the synchronization reference source, the UE shall not drop any other SLSS transmission for the purpose of selection or reselection to other potential synchronization source while receiving the SLSS from the current synchronization reference source. “UE stops the candidate SLSS detection” means that a sidelink UE only receives the SLSS from the current synchronization reference source and drops any other SLSS transmission.

In another embodiment of the present application, the UE only performs the candidate SLSS detection within a sidelink DRX active time duration when the UE is configured with DRX operation. For example, the UE may perform the candidate SLSS detection during a sidelink DRX active time period and stops the candidate SLSS detection during a sidelink DRX inactive time period when the UE is configured with a sidelink DRX configuration. The sidelink DRX active time period includes the total duration that the UE monitors physical sidelink control channel (PSCCH), for example, a time duration of a sidelink DRX on-duration period and a time duration while a sidelink DRX related timer, e.g., DRX inactivity timer, DRX retransmission timer, etc., is running. In other words, the time period for the UE's performing the candidate SLSS detection starts from the beginning of the active time duration and stops at the end of the active time duration for a specific DRX cycle. The time period for the UE's stopping the candidate SLSS detection starts from the beginning of the inactive time duration and stops at the end of the inactive time duration for a specific DRX cycle.

In another embodiment of the present application, the UE performs the candidate SLSS detection within a specified time duration to receive SLSS from other candidate synchronization reference source(s) periodically.

For example, the period for performing the candidate SLSS detection and the specified time duration for performing the candidate SLSS detection are configured by a BS or pre-configured. The period and the specified time duration are configured or pre-configured based on a sidelink DRX configuration when the UE is configured with the sidelink DRX configuration or based on the BS's implementation or the UE's implementation. In another example, the period and the specified time duration can be configured by a BS for in-coverage UE or pre-configured for out-of-coverage UE.

In the above embodiments, the UE may search a potential or candidate synchronization reference source(s) when performing the candidate SLSS detection, and may select one synchronization reference source for sidelink communication with another UE.

Furthermore, in some embodiments of the present application, in step 202, the UE may stop the candidate SLSS detection during a specified time window when a new synchronization reference source is selected or reselected. In particular, when a new synchronization reference source is selected or reselected, the UE only receives the synchronization signal from the selected or reselected synchronization reference source and stops performing other candidate SLSS detection during the specified time window.

The specified time window is started after the new synchronization reference source is selected or reselected, and the duration of the specified time window can be configured by a BS or pre-configured, such as configured by a BS for in-coverage UE or pre-configured for out-of-coverage UE. After the specified time window, the UE may perform candidate SLSS detection, for example, using any method as described herein.

In some other embodiments, to avoid potential un-synced synchronization reference happening and dropping out the candidate SLSS detection by the UE, some trigger conditions for candidate SLSS detection should be defined to detect or select new synchronization reference source. Thus, the UE may perform candidate SLSS detection based on a trigger condition.

In an embodiment of the present application, the UE may perform the candidate SLSS detection to select or reselect a synchronization reference source for a sidelink communication with another UE when a quality of service (QOS) requirement of an upcoming service for a sidelink communication with another UE is within a first threshold range. The QoS requirement of the upcoming service for the sidelink communication with another UE may indicate, such as, service latency (e.g., packet delay budget), reliability (e.g., packet error rate), priority level etc., for the sidelink communication with another UE. Thus, in an example, when the service latency (e.g., packet delay budget) of the upcoming service is required to be within a threshold range (including lower than a threshold), the UE will perform the candidate SLSS detection. In another example, when the packet error rate of the upcoming service is required to be within a threshold range (including lower than a threshold), the UE will perform the candidate SLSS detection. In another example, when the priority level of the upcoming service is within a threshold range (including higher than a threshold), the UE will perform the candidate SLSS detection.

In another embodiment of the present application, the UE may perform the candidate SLSS detection to select or reselect a synchronization reference source for a sidelink communication with another UE when a measured received power (such as physical sidelink broadcast channel (PSBCH)-reference signal received power (RSRP)) value of the current synchronization reference source of the UE is lower than a second threshold during a time period.

In another embodiment of the present application, the UE may perform the candidate SLSS detection to select or reselect a synchronization reference source for a sidelink communication with another UE when a range-based signal (e.g. distance or direction information) from the current synchronization reference source of the UE is within a third threshold range during a time period.

The above described embodiments for performing candidate SLSS detection based on a trigger condition may be applied for the UEs with any of the synchronization reference sources as listed in the Table 1. The above described threshold, threshold range, and time period may be configured by a BS or pre-configured, such as configured by a BS for in-coverage UE or pre-configured for out-of-coverage UE.

In another embodiment of the present application, in the case that the UE is directly or indirectly synchronized to a BS (that is, the UE has a synchronization reference source from the BS directly or indirectly), the UE performs the candidate SLSS detection to select or reselect a synchronization reference source for a sidelink communication with another UE when a measurement result (e.g. RSRP value) indicates that the UE moves into an edge of a cell of the BS or out of a cell coverage of the BS. For example, when the RSRP value between a UE and a BS is lower than a threshold, or when the UE cannot receive the physical broadcast channel (PBCH) information from the BS, which means that the UE moves into an edge of a cell of the BS or out of a cell coverage of the BS, the UE may perform the candidate SLSS detection to select or reselect a synchronization reference source for a sidelink communication.

In another embodiment of the present application, in the case that the UE is directly or indirectly synchronized to a GNSS (that is, the UE has a synchronization reference source from the GNSS directly or indirectly), the UE performs the candidate SLSS detection to select or reselect a synchronization reference source for a sidelink communication with another UE when the GNSS becomes not reliable. For example, the GNSS may become not reliable, e.g. in the tunnel or underground scenario in accordance with TS 38.101 and TS 38.133, for example, the UE does not meet the timing accuracy requirements and frequency accuracy requirements as defined in TS 38.101 and TS38.133.

In another embodiment of the present application, in the case that a current synchronization reference source of the UE is another UE which is not synchronized to a GNSS or a BS directly or indirectly (that is, the UE has a synchronization reference source from P6 group UEs in Table 1 (i.e. any other UEs, starting with the UE with the highest PSBCH-RSRP results)), the UE performs the candidate SLSS detection to select or reselect a synchronization reference source for a sidelink communication with another UE when at least one of the trigger conditions is met: (1) the GNSS becomes reliable (for example, the UE considers GNSS as a reliable synchronization reference, and the UE shall meet timing accuracy requirements and frequency accuracy requirements as defined in TS 38.301-1 and TS 38.133); or (2) information of at least one cell of a BS is detected. For example, the UE performs the candidate SLSS detection when cell(s) information is detected, e.g., the UE transits to an RRC-INACTIVE or RRC-IDLE state (e.g., from out-of-coverage), or cell selection is initiated.

When any one of the above trigger conditions is met, the UE triggers candidate SLSS detection to search potential SLSS and select a new synchronization reference source. When a new available synchronization reference source is selected, the UE synchronizes to the new synchronization reference source and stops performing the candidate SLSS detection within a specific time window. After the specified time window, the UE may perform the candidate SLSS detection, for example, using any method as described herein.

In the above embodiments, the time period-based condition and/or the trigger conditions can be configured by a BS with radio resource control (RRC) signaling or system information block (SIB) signaling, or pre-configured. For example, the configurations of the time period-based condition and/or the trigger conditions can be transmitted from the BS to the UE by RRC signaling directly when the UE is in the RRC-CONNECTED state, or transmitted from the BS to the UE by SIB signaling when the UE is in the RRC-IDLE or RRC-INACTIVE state. The configurations of the time period-based condition and/or the trigger conditions can also be pre-configured in the UE when the UE is out of coverage.

It should be understood that whether the UE performs the candidate SLSS detection based on a time period-based condition or a trigger condition or both of them may be configured, pre-configured, or depend on the implementation of the UE.

Therefore, embodiments of the present application can realize power saving for a sidelink UE without performing a full-time synchronization search.

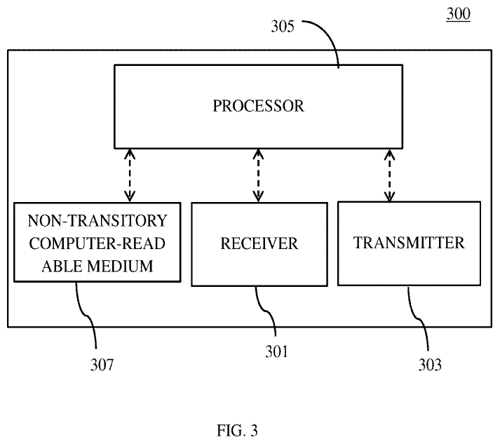

FIG. 3 illustrates a simplified block diagram of an exemplary apparatus 300 according to some embodiments of the present application. In some embodiments of the present disclosure, the apparatus 300 may be the UE 101 as illustrated in FIG. 1 or other embodiments of the present application.

As shown in FIG. 3, the apparatus 300 may include a receiver 301, a transmitter 303, a processer 305, and a non-transitory computer-readable medium 307. The non-transitory computer-readable medium 307 has computer executable instructions stored therein. The processer 305 is configured to be coupled to the non-transitory computer readable medium 307, the receiver 301, and the transmitter 303. It can be contemplated that, in some other embodiments of the present application, the apparatus 300 may include more computer-readable mediums, receivers, transmitters and processors according to practical requirements. In some embodiments of the present application, the receiver 301 and the transmitter 303 can be a wireless receiver and a wireless transmitter, respectively, and can be integrated into a single device, such as a wireless transceiver. In certain embodiments, the apparatus 300 may further include an input device, a memory, and/or other components.

In some embodiments of the present application, the non-transitory computer-readable medium 307 may have stored thereon computer-executable instructions to cause the processer 305 to implement the method performed by the UE according to embodiments of the present application. For example, the processer 305 may be configured to perform SLSS detection, e.g., via the receiver 301 and the transmitter 303, to select or reselect a synchronization reference source for a sidelink communication with another UE, based on at least one of a time period-based condition and a trigger condition. It should be understood that the processer 305 may be further configured to perform other operations or actions in the above description, which will not be described in detail for avoiding repetition.

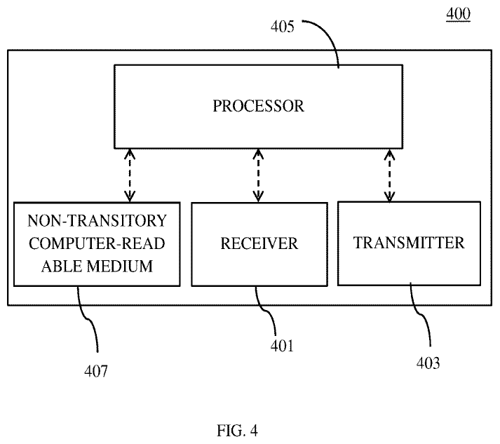

FIG. 4 illustrates a simplified block diagram of another exemplary apparatus 400 according to some embodiments of the present application. In some embodiments of the present disclosure, the apparatus 400 may be the BS 102 as illustrated in FIG. 1 or other embodiments of the present application.

As shown in FIG. 4, the apparatus 400 may include a receiver 401, a transmitter 403, a processer 405, and a non-transitory computer-readable medium 407. The non-transitory computer-readable medium 407 has computer executable instructions stored therein. The processer 405 is configured to be coupled to the non-transitory computer readable medium 407, the receiver 401, and the transmitter 403. It can be contemplated that, in some other embodiments of the present application, the apparatus 400 may include more computer-readable mediums, receivers, transmitters and processors according to practical requirements. In some embodiments of the present application, the receiver 401 and the transmitter 403 can be a wireless receiver and a wireless transmitter, respectively, and can be integrated into a single device, such as a wireless transceiver. In certain embodiments, the apparatus 400 may further include an input device, a memory, and/or other components.

In some embodiments of the present application, the non-transitory computer-readable medium 407 may have stored thereon computer-executable instructions to cause the processor 405 to implement the method performed by the BS according to embodiments of the present application.

Persons skilled in the art should understand that as the technology develops and advances, the terminologies described in the present application may change, and should not affect or limit the principle and spirit of the present application.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method performed by a first user equipment (UE), the method comprising:
performing candidate sidelink synchronization signal (SLSS) detection to select or reselect a synchronization reference source for a sidelink communication with a second UE, based on at least one of a time period-based condition or a trigger condition.

2. The method of claim 1, wherein the first UE is configured with a sidelink discontinuous reception (DRX) configuration, and the first UE performs the candidate SLSS detection during a sidelink DRX on-duration period and stops the candidate SLSS detection during a sidelink DRX off-duration period.

3. The method of claim 1, wherein claim 1, wherein:
the first UE is configured with a sidelink discontinuous reception (DRX) configuration, and the first UE performs the candidate SLSS detection during a sidelink DRX active time period and stops the candidate SLSS detection during a sidelink DRX inactive time period; and
the sidelink DRX active time period includes a time duration of a sidelink DRX on-duration period and a time duration while a sidelink DRX related timer is running.

4. The method of claim 1, wherein:
the first UE performs the candidate SLSS detection within a specified time duration periodically; and
a period for performing the candidate SLSS detection and the specified time duration for performing the candidate SLSS detection are configured by a base station (BS) or pre-configured.

5-6. (canceled)

7. The method of claim 1, further comprising:
stopping the candidate SLSS detection during a specified time window when a new synchronization reference source is selected or reselected.

8. The method of claim 7, wherein the specified time window is started after the new synchronization reference source is selected or reselected, and a duration of the specified time window is configured by a base station (BS) or pre-configured.

9. The method of claim 1, wherein the first UE performs the candidate SLSS detection to select or reselect the synchronization reference source for the sidelink communication with the second UE based at least in part on the trigger condition comprising at least one of:
a quality of service (QOS) requirement of an upcoming service for the sidelink communication with the second UE is within a first threshold range;
a measured received power value of a current synchronization reference source of the first UE is lower than a second threshold during a time period; or
a range-based signal from the current synchronization reference source of the first UE is within a third threshold range during the time period.

10-14. (canceled)

15. A user equipment (UE) for wireless communication, comprising:
at least one memory; and
at least one processor coupled with the at least one memory and configured to cause the UE to perform candidate sidelink synchronization signal (SLSS) detection to select or reselect a synchronization reference source for a sidelink communication with another UE, based on at least one of a time period-based condition or a trigger condition.

16. The UE of claim 15, wherein the UE is configured with a sidelink discontinuous reception (DRX) configuration, and is configured to perform the candidate SLSS detection during a sidelink DRX on-duration period and stop the candidate SLSS detection during a sidelink DRX off-duration period.

17. The UE of claim 15, wherein:
the UE is configured with a sidelink discontinuous reception (DRX) configuration, and is configured to perform the candidate SLSS detection during a sidelink DRX active time period and stop the candidate SLSS detection during a sidelink DRX inactive time period; and
the sidelink DRX active time period includes a time duration of a sidelink DRX on-duration period and a time duration while a sidelink DRX related timer is running.

18. The UE of claim 15, wherein:
the UE performs the candidate SLSS detection within a specified time duration periodically; and
a period for performing the candidate SLSS detection and the specified time duration for performing the candidate SLSS detection are configured by a base station (BS) or pre-configured.

19. The UE of claim 15, wherein the at least one processor is configured to cause the UE to stop the candidate SLSS detection during a specified time window when a new synchronization reference source is selected or reselected.

20. The UE of claim 19, wherein the specified time window is started after the new synchronization reference source is selected or reselected, and a duration of the specified time window is configured by a base station (BS) or pre-configured.

21. The UE of claim 15, wherein:
the UE performs the candidate SLSS detection to select or reselect the synchronization reference source for the sidelink communication based at least in part on the trigger condition comprising at least one of:
a quality of service (QOS) requirement of an upcoming service for the sidelink communication is within a first threshold range;
a measured received power value of a current synchronization reference source of the UE is lower than a second threshold during a time period; or
a range-based signal from the current synchronization reference source of the UE is within a third threshold range during the time period.

22. A processor for wireless communication, comprising:
at least one controller coupled with at least one memory and configured to cause the processor to perform candidate sidelink synchronization signal (SLSS) detection to select or reselect a synchronization reference source for a sidelink communication, based on at least one of a time period-based condition or a trigger condition.

23. The processor of claim 22, wherein a user equipment (UE) is configured with a sidelink discontinuous reception (DRX) configuration, and is configured to perform the candidate SLSS detection during a sidelink DRX on-duration period and stop the candidate SLSS detection during a sidelink DRX off-duration period.

24. The processor of claim 22, wherein:
a user equipment (UE) is configured with a sidelink discontinuous reception (DRX) configuration, and is configured to perform the candidate SLSS detection during a sidelink DRX active time period and stop the candidate SLSS detection during a sidelink DRX inactive time period; and
the sidelink DRX active time period includes a time duration of a sidelink DRX on-duration period and a time duration while a sidelink DRX related timer is running.

25. The processor of claim 22, wherein:
the candidate SLSS detection is performed within a specified time duration periodically; and
a period for performing the candidate SLSS detection and the specified time duration for performing the candidate SLSS detection are configured by a base station (BS) or pre-configured.

26. The processor of claim 22, wherein the at least one processor is configured to cause the processor to stop the candidate SLSS detection during a specified time window when a new synchronization reference source is selected or reselected.

27. The processor of claim 26, wherein the specified time window is started after the new synchronization reference source is selected or reselected, and a duration of the specified time window is configured by a base station (BS) or pre-configured.
